(19) United States
(12) Patent Application Publication
(10) Pub. No.: US 2012/0239317 A1
(43) Pub. Date: Sep. 20, 2012

(54) CONTROLLING DEVICE AND METHOD FOR ABNORMALITY PREDICTION OF SEMICONDUCTOR PROCESSING EQUIPMENT

(76) Inventor: Cheng-Wei LIN, Hsinchu (TW)

(21) Appl. No.: 13/156,864

(22) Filed: Jun. 9, 2011

(30) Foreign Application Priority Data
Mar. 14, 2011 (TW) 100108595

(51) Int. Cl. G06F 19/00; G01N 29/44

(52) U.S. Cl. 702/56; 702/81

(57) ABSTRACT

Disclosed in this invention is a controlling device for abnormality prediction of semiconductor processing equipment. The controlling device includes a multiplexer connecting a plurality of vibration sensors to a spectrum analyzer. Therein, the vibration sensors are non-destructively installed to a variable-frequency rotating mechanism inside the semiconductor processing equipment. The multiplexer includes an adapter and at least a modularized multi-channel connecting assembly plugged into the adapter where the number of the connected vibration sensors is less than the number of the signal connecting terminals of the multiplexer so that at least one terminal is unconnected with the vibration sensors. Additionally, a control signal wire connects the unconnected terminal to a corresponding controller of the variable-frequency rotating element. The vibration spectrum analyzer is configured to record and collect both vibration signals and control signals where these signals are transformed into time-domain waveforms to track the lifetime of the equipment, to predict the failure of the equipment, and to reduce equipment down time, parts waiting time, and equipment repair time of the semiconductor processing equipment.

### FIELD OF THE INVENTION

The present invention relates to controlling devices and controlling methods to handle semiconductor devices or parts, and more specifically to a controlling device and a controlling method for abnormality prediction of semiconductor processing equipment.

### BACKGROUND OF THE INVENTION

There are various semiconductor processing equipments in the production line of semiconductor fabrication such as die bonders, wire bonders, molding equipment, etc. Since the existing prediction maintenance methodology is not well-developed and not really implemented in semiconductor processing equipment, therefore, regular maintenance is the only way to prevent sudden failure and to extend the lifetime of parts of semiconductor processing equipment where equipment engineers have to adjust semiconductor processing equipment while running or to shut down semiconductor processing equipment to maintain or disassemble and repair. Even with the best efforts, semiconductor processing equipment is still under the risk of suddenly breaking down leading to idle without any throughput due to repairing the semiconductor processing equipment or the worst, waiting for parts. Since semiconductor processing equipment is very expensive, how to keep the highest throughput as possible is a challenge to effectively reduce processing cost.

In conventional manufacture equipment, vibration spectrum analyzer is implemented to measure vibration to decide whether manufacture equipment is abnormal or parts needed to be replaced, since constant-rotation mechanism is often implemented in conventional manufacture equipment where constant rotation implies constant vibration frequency which can easily be measured. Since constant-rotation mechanism is normally driven by a single driver component, therefore, measured results of different conventional manufacture equipment at different measurement time can easily be recorded, collected, and compared by spectrum analyzer through Fast Fourier Transform (FFT) to make conclusion and judgment of the status of conventional manufacture equipment. Moreover, the sampling period of the constant-rotation mechanism would not change so that data can easily be measured.

However, it is not effective to implement the same measuring equipment and analysis methodology into semiconductor industries since variable-frequency rotation rail or linear-motion slide rail are often implemented in semiconductor processing equipment where rotation speeds keep changing with irregular periods, therefore, actual vibration frequency among different semiconductor processing equipment can not easily be measured by conventional spectrum analyzer through FFT for comparison due to the constant changing of rotation speeds. Furthermore, a plurality of driver components are activated simultaneously at the same measurement location driven by different variable-frequency servers with different phases during the measurement period leading to very complicated data where vibration sources can not easily be identified. Moreover, since the driver components are discontinuously activated with very short activated time, it is always happened that semiconductor processing equipment starts or stops during the measurement period caused interference to the measured results leading to measurement errors.

### SUMMARY OF THE INVENTION

The main purpose of the present invention is to provide a controlling device and a method for abnormality prediction of semiconductor processing equipment to track the lifetime of crucial parts in semiconductor processing equipment and to predict the possible breaking down period of semiconductor processing equipment to greatly reduce equipment down time, parts waiting time, and equipment repair time of semiconductor processing equipment and to further prevent producing mass abnormal products.

The second purpose of the present invention is to provide a controlling device and method for abnormality prediction of semiconductor processing equipment to simultaneously measure, collect, and analyze vibration signals of a plurality of variable-frequency rotating mechanisms installed in the same semiconductor processing equipment or in different semiconductor processing equipment.

According to the present invention, a controlling device for abnormality prediction of semiconductor processing equipment is disclosed where a first variable-frequency rotating mechanism and a first controller to drive the first variable-frequency rotating mechanism are installed in the semiconductor processing equipment. The controlling device primarily comprises a multiplexer, a plurality of first vibration sensors, a first control signal wire, and a vibration spectrum analyzer where the multiplexer includes an adapter and at least a multi-channel connecting assembly plugged into the adapter. The multi-channel connecting assembly has a plurality of signal connecting terminals. The vibration sensors are non-destructively installed on one or more vibration parts of the first variable-frequency rotating mechanism and connected to the signal connecting terminals where the number of the connected first vibration sensors is less than the number of the signal connecting terminals of the multiplexer so that at least one of the signal connecting terminals is unconnected with the first vibration sensors. The first control signal wire connects the first controller to the unconnected signal connecting terminal. The vibration spectrum analyzer is connected to the adapter to collect and record the vibration signals and the corresponding control signals and transform into time-domain waveforms through FFT(Fast Fourier Transform).

According to the present invention, a controlling method for abnormality prediction of semiconductor processing equipment is also disclosed. The primary steps includes setting up the controlling device for abnormality prediction in semiconductor processing equipment, collecting a control signal from the first control signal wire as the starting point of measurement time, and calculating Root Mean Square (RMS) of the vibration amplitudes of the vibration parts during activation of the first variable-frequency rotating mechanism to set up Statistic Process Control (SPC) limits for abnormality.

The controlling device for abnormality prediction according to the present invention has the following advantages and effects:
1. The vibration spectrum analyzer is connected to the multi-channel connecting assembly through the adapter. Through the number mismatch between the connected vibration sensors and the signal connecting terminals of the multi-channel connecting assembly as a technical mean, the signal connecting terminals are not only connected to the vibration parts but also connected to the controller of semiconductor processing equipment by a control signal wire. The vibration spectrum analyzer can record and collect the vibration signals and the corresponding control signal and then transform into time-domain waveforms through FFT to track the lifetime of crucial parts in semiconductor processing equipment and to predict the possible breaking down period of semiconductor processing equipment to greatly reduce equipment down time, parts waiting time, and equipment repair time of semiconductor processing equipment and to further prevent producing mass abnormal products.
2. Through a plurality of multi-channel connecting assembly plugged into one adapter and the specific connection of their signal connecting terminals as a technical mean, vibration signals and control signals of a plurality of variable-frequency rotating mechanisms installed in the same semiconductor processing equipment or in different semiconductor processing equipment can be measured, collected, and analyzed simultaneously.

### DESCRIPTION OF THE DRAWINGS

FIG. 1 is a major structural drawing of a controlling device for abnormality prediction installed in semiconductor processing equipment according to the first embodiment of the present invention.

FIG. 2 is a partially three-dimensional view showing a plurality of vibration sensors of the controlling device installed in the semiconductor processing equipment according to the first embodiment of the present invention.

FIGS. 3A and 3B are three-dimensional views of a multiplexer of the controlling device before and after assembling according to the first embodiment of the present invention.

FIGS. 4A and 4B are three-dimensional views of a vibration sensor of the controlling device with and without a magnetic sensing head according to the first embodiment of the present invention.

FIGS. 5A and 5B are three-dimensional rear and front views of the magnetic sensing head for the vibration sensor according to the first embodiment of the present invention.

FIG. 6 is another major structural drawing of a controlling device for abnormality prediction installed in semiconductor processing equipment according to the second embodiment of the present invention.

FIGS. 7A and 7B are three-dimensional views of a multiplexer of the controlling device before and after assembling according to the second embodiment of the present invention.

FIG. 8 shows time-domain waveforms of the recorded and collected vibration signals and corresponding control signal by the controlling device according to the present invention.

FIGS. 9 to 21 are the operation interfaces/windows of the vibration spectrum analyzer of the controlling device in the controlling processes for abnormality prediction according to the present invention.

### DETAILED DESCRIPTION OF THE INVENTION

With reference to the attached drawings, the present invention is described by means of the embodiment(s) below where the attached drawings are simplified for illustration purposes only to illustrate the structures or methods of the present invention by describing the relationships between the components and assembly in the present invention. Therefore, the components shown in the figures are not expressed with the actual numbers, actual shapes, actual dimensions, nor with the actual ratio. Some of the dimensions or dimension ratios have been enlarged or simplified to provide a better illustration. The actual numbers, actual shapes, or actual dimension ratios can be selectively designed and disposed and the detail component layouts may be more complicated.

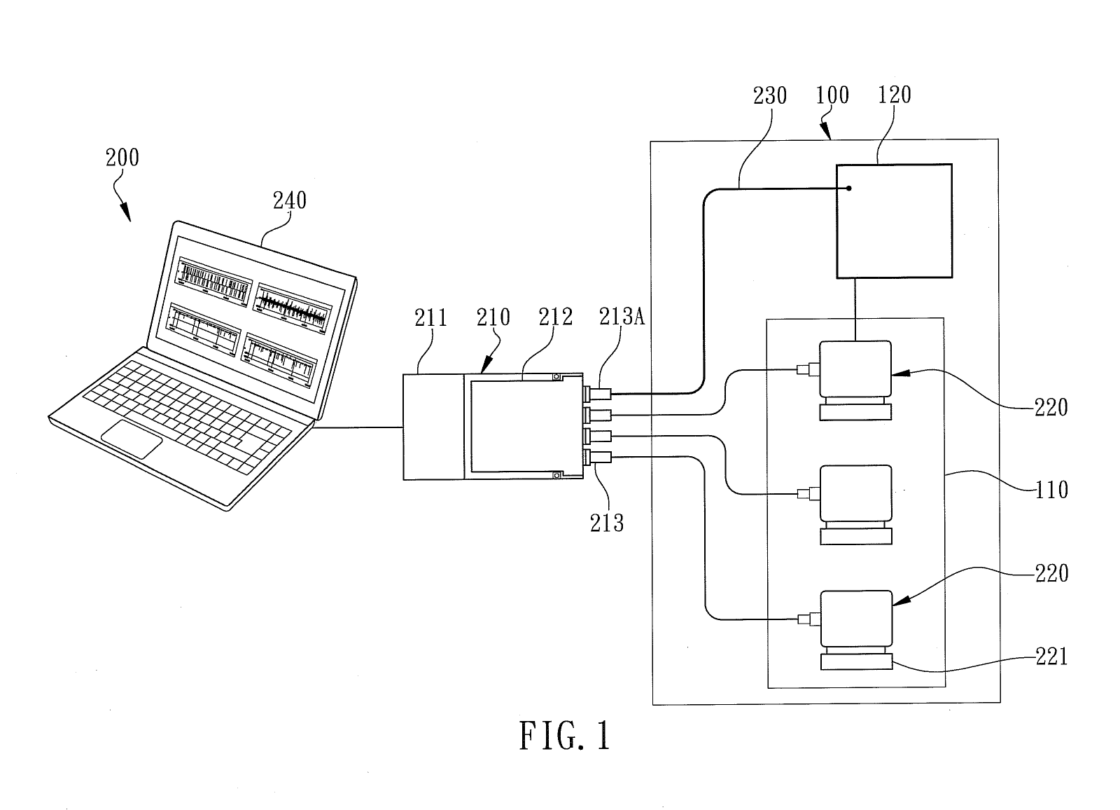

According to the first embodiment of the present invention, a controlling device 200 of semiconductor processing equipment 100 is illustrated in FIG. 1 for a major structural drawing. The controlling device 200 includes a multiplexer 210, a plurality of first vibration sensors 220, a first control signal wire 230, and a vibration spectrum analyzer 240. The controlling device 200 can be implemented in various semiconductor processing equipments in the present invention. The semiconductor processing equipment 100 includes a first variable-frequency rotating mechanism 110 and a first controller 120 to drive the first variable-frequency rotating mechanism 110 installed inside.

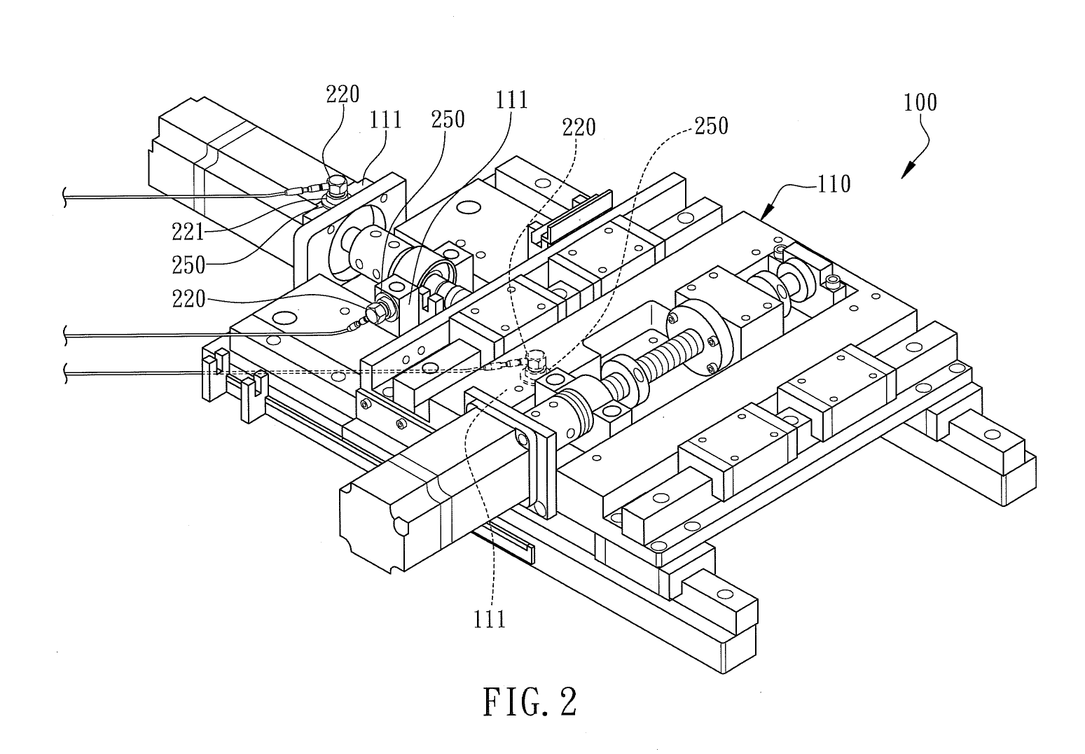

The semiconductor processing equipment 100 can be one kind of semiconductor packaging equipment such as wire bonder, die bonder, BGA ball placer, on-line IC marker, and lead scanner, or any other semiconductor processing equipment for research and development such as die saw machine, sputter, vacuum evaporator, cleaning equipment, CVD, PVD, wet station, RTP, CMP, stepper, etcher, plating system, ion implanter, asher, diffusion oven, annealing equipment, and multi-chamber automated equipment. The first variable-frequency rotating mechanism 110 in the semiconductor processing equipment 100 has a variable-frequency rotating rail or a linear slide rail where the rotation speed keeps changing or discontinuously rotates. As shown in FIG. 2, in the present embodiment, the first variable-frequency rotating mechanism 110 may be Y-axis moving stage or X-axis moving stage of a die bonder where both stages are perpendicular to each other. As shown in FIG. 1, the first variable-frequency rotating mechanism 110 is electrically connected to the first controller 120 where the first variable-frequency rotating mechanism 110 is controlled and driven by the first controller 120.

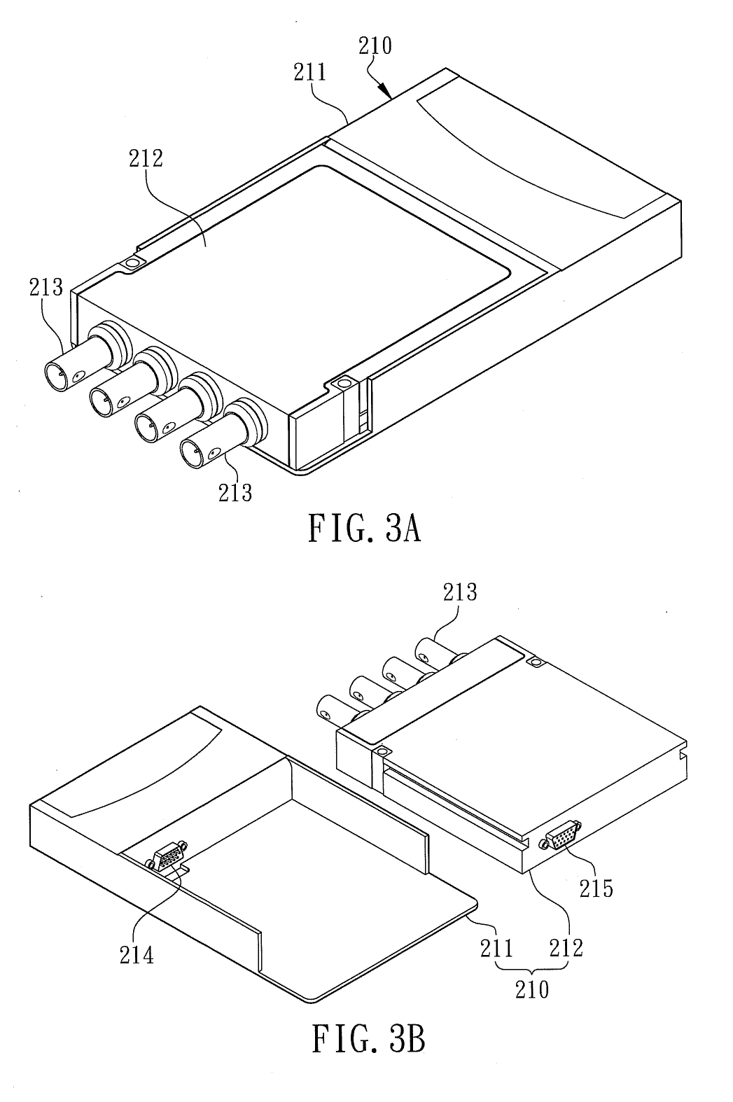

As shown in FIG. 3A and FIG. 3B, the multiplexer 210 includes an adapter 211 and at least a modularized multi-channel connecting assembly 212 plugged into the adapter 211. The modularized multi-channel connecting assembly 212 has a plurality of signal connecting terminals 213. The signal connecting terminals 213 serve as signal input port and most of the terminals can be connected to one or more vibration parts 111 of the first variable-frequency rotating mechanism 110 for vibration signal recording and collecting. In the present embodiment, the adapter 211 can be a single-cassette type adapter to modularly connect to a multi-channel connecting assembly 212. To be more specific, the adapter 211 can be a high-speed USB carrier for external interconnection. To be described in more detail, as shown in FIG. 3B, the adapter 211 has at least a connecting port 214 where the multi-channel connecting assembly 212 has a corresponding connecting port 215. The connecting ports 214 and 215 in pairs are in male and female configuration so that when both connecting ports 214 and 215 are connected, the multi-channel connecting assembly 212 is also plugged into the adapter 211. The adapter 211 further has an output port (not shown in the figure) which can be a USB connecter with appropriate wiring to connect to the vibration spectrum analyzer 240 where the vibration spectrum analyzer 240 can be an external computer, a notebook computer, an analyzer, an A/D converter, a display, or a recorder. In a more specific embodiment, the multiplexer 210 can be Dynamic Signal Analyzer (DSA) offered by National Instruments to acquire various vibration signals of semiconductor processing equipment 100 through the multiplexer 210 and to further acquire control signals (which are described in more detail later) for in-depth data processing and analysis with the corresponding software packages.

As shown in FIG. 1 and FIG. 2, the first vibration sensors 220 are non-destructively installed on the vibration parts 111 of the first variable-frequency rotating mechanism 110 and is connected to the signal connecting terminals 213 without changing or damaging the internal structure of semiconductor processing equipment 100 without affecting the maintenance and repair of the equipment. More specifically, the number of the connected first vibration sensors 220 is less than the number of the signal connecting terminals 213 of the multiplexer 210 so that at least one of the signal connecting terminals 213 is not connected with the first vibration sensors 220. In the present embodiment, as shown in FIG. 1, the number of the connected first vibration sensors 220 is three where there are four signal connecting terminals 213 of the multi-channel connecting assembly 212. When most of the signal connecting terminals 213 are selected to connect to the first vibration sensor 220, there is at least one unconnected signal connecting terminal 213A. The first control signal wire 230 electrically connects the unconnected signal connecting terminal 213A to the first controller 120. Therefore, one of the signal connecting terminals 213 is electrically connected to the first controller 120 so that the multiplexer 210 can not only measure the vibration signals of the variable-frequency rotating mechanism 110 but also measure the corresponding control signal of the controller 120. When a control signal is sent by the first controller 120 to drive the first variable-frequency rotating mechanism 110, the synchronized control signal can simultaneously be sensed by the multi-channel connecting assembly 212 through the first control signal wire 230 when connected in parallel with the first controller 120. Moreover, the first vibration sensors 220 also can sense the synchronized vibration signals at different vibration parts of the first variable-frequency rotating mechanism 110 so that the control signals and the corresponding vibration signals can be recorded and collected. Preferably, the first control signal wire 230 has a tolerance voltage between ±5 volts sent from the first controller 120 to the corresponding signal connecting terminals 213A to ensure the signal connecting terminals 213 of the multi-channel connecting assembly 212 can be used to transmit control signals as well as vibration signals. As a result, all of the signal connecting terminals 213 are universal. In other words, the multi-channel connecting assembly 212 does not need special-design signal connecting terminals 213 to transmit control signals. Any one of the unconnected signal connecting terminals 213 can be used to connect to the first control signal wire 230 as long as the operation interface of the vibration spectrum analyzer 240 is correctly set up.

As shown in FIG. 2, the vibration parts 111, where the first vibration sensors 220 are attached to, may include a vibration source, a vibration part, and a vibration rotating element such as server driving motor, motor front-end fixing ring, ball bearing rod, working stage driven by a rod, or high-speed axis. The installed positions of the vibration parts 111 by the first vibration sensor 220 are the locations which are directly related to the vibration sources so that the vibration signals can be measured. Normally, the vibration sources of the vibration parts 111 of the semiconductor processing equipment 100 have different rotation speeds, loading, vibration frequencies, and vibration amplitudes, therefore, criteria specification can not easily be decided by ISO-10816 or by other standards.

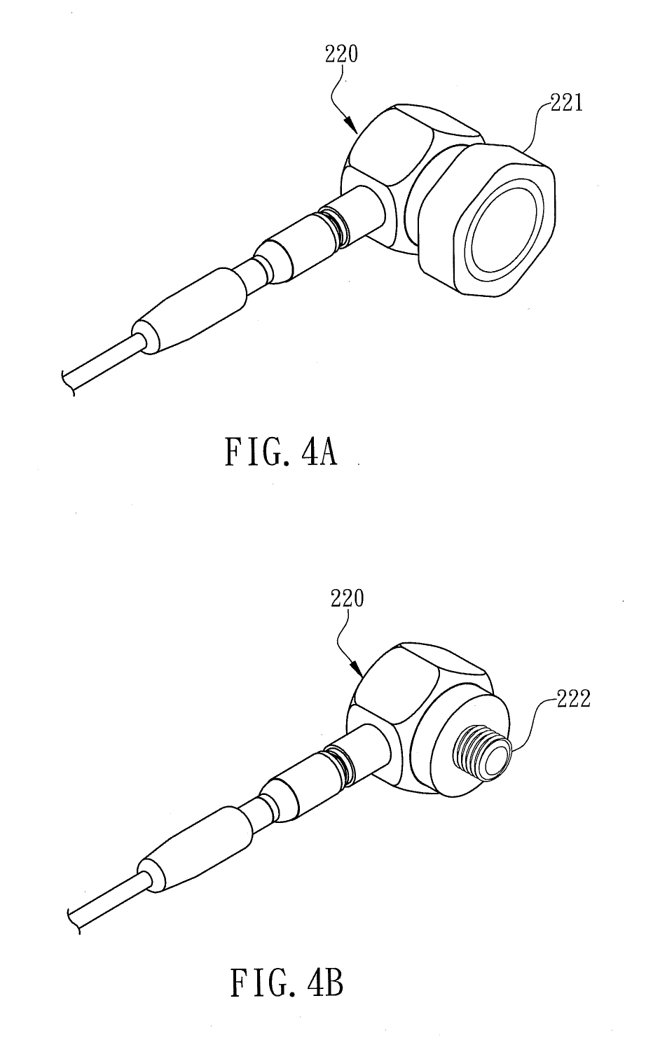

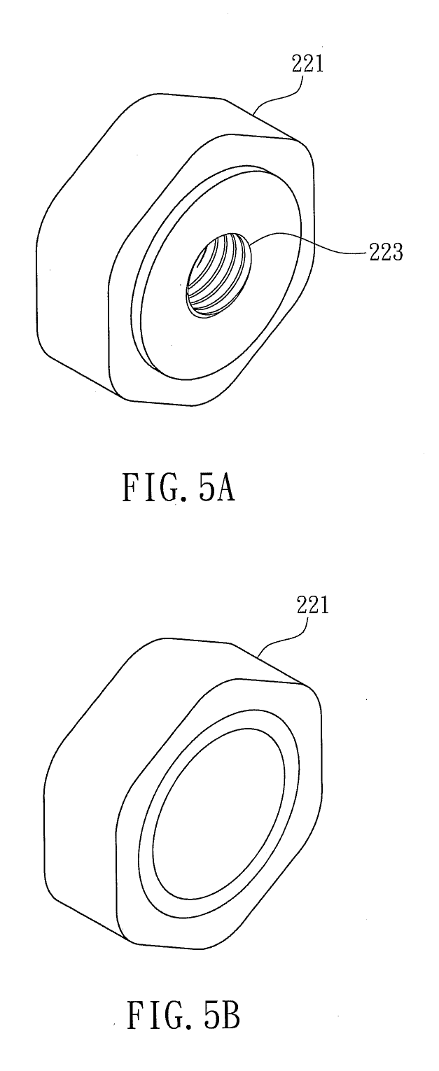

The non-destructively installation of the first vibration sensors 220 further is described in detail as follows. As shown in FIG. 4A, each first vibration sensor 220 has a magnetic sensor head 221 and a body. As shown in FIG. 4B, the body of each first vibration sensor 220 may has a screw rod 222 and the magnetic head 221 is screwed with the screw rod 222 so that the magnetic head 221 is modularly jointed with the body of corresponding first vibration sensor 220 for easy replacement or repair. Therefore, the first vibration sensors 220 can be non-destructively installed on the designated vibration parts 111 inside semiconductor processing equipment 100. To be more specific, as shown in FIG. 4B and FIG. 5A, the magnetic sensing head 221 has a screw hole 223 disposed at the back side to joint to the screw rod 222 where the screw rod 222 does not penetrate through the magnetic sensing head 221. As shown in FIG. 5B, a receiver is installed at the front side of the magnetic sensing head 221 to clearly receive the vibration signals from designated vibration parts 111. The magnetic sensing head 221 is made of Neodymium magnet with powerful magnetic force. In the present embodiment, the shape of the magnetic sensing head 221 can be hexagon but is not limited. In other embodiment, the shape of the magnetic sensing head 221 can be other shapes. The first vibration sensors 220 can be connected to some of the signal connecting terminals 213.

As shown in FIG. 2, the controlling device 200 further includes a plurality of magnetic attachments 250 so that when the designated vibration parts 111 for measurement are made of non-magnetic materials, then the magnetic attachments 250 can be attached to the vibration parts 111 for the magnetic connections of the magnetic sensing heads 221. In other words, the magnetic attachments 250 can be pre-attached to the vibration parts 111 of the first variable-frequency rotating mechanism 110 so that the corresponding first vibration sensors 220 can be attached to. Moreover, the magnetic attachments 250 can serve as position markers for the first vibration sensors 220. The magnetic attachment 250 is made of magnetic materials such as iron or steel. The magnetic attachment 250 can be attached to the designated vibration parts 111 by adhesive. Preferably, the dimension of the magnetic attachments 250 is the same as or slightly larger than the dimension of the magnetic sensing heads 221 to provide enough attaching area to increase magnetic force. Since the first vibration sensors 220 are joined to the magnetic attachments 250 by magnetic force which are very easy to be positioned, installed and removed, therefore, the structure of the semiconductor processing equipment 100 is not changed or damaged due to the installation of the first vibration sensors 220. Moreover, the expensive semiconductor processing equipment 100 can keep the warranty, maintenance, and service provided by the equipment vendors.

As shown in FIG. 1, the vibration spectrum analyzer 240 is electrically connected to the adapter 211 of the multiplexer 210 to record and collect the vibration signals and corresponding control signal and then transform into time-domain waveforms through FFT so that the lifetime of crucial parts in semiconductor processing equipment 100 can easily be tracked and the possible breaking down period of semiconductor processing equipment 100 can easily be predicted to greatly reduce equipment down time, parts waiting time, and equipment repair time and to further prevent producing mass abnormal products. To be more specific, the vibration spectrum analyzer 240 can be a PC, a portable notebook computer, an analyzer, an A/D converter, a display, or a recorder having the capability of display, calculation, analysis, and storage. Preferably, the vibration spectrum analyzer 240 includes or connects to a database server (not shown in the figure) to store and read the related information or maintenance records of the semiconductor processing equipment 100. The vibration spectrum analyzer 240 may continuously monitor or sampling monitor the vibration signals and the corresponding control signals collected and recorded by the first vibration sensor 220 where the measured data are FFT into time-domain waveforms and arranged according to time sequence so that abnormal equipment can be identified in time through data analysis to remind equipment engineers to take actions and find the possible abnormal or failure causes before producing mass abnormal products or sudden failure of semiconductor processing equipment 100. In the present embodiment, the vibration spectrum analyzer 240 can be implemented to calculate RMS, vibration peaks, crest factors, and vibration peak numbers to plot a trend chart or statistic reports according to day/week/month to build the abnormal database of the semiconductor processing equipment 100.

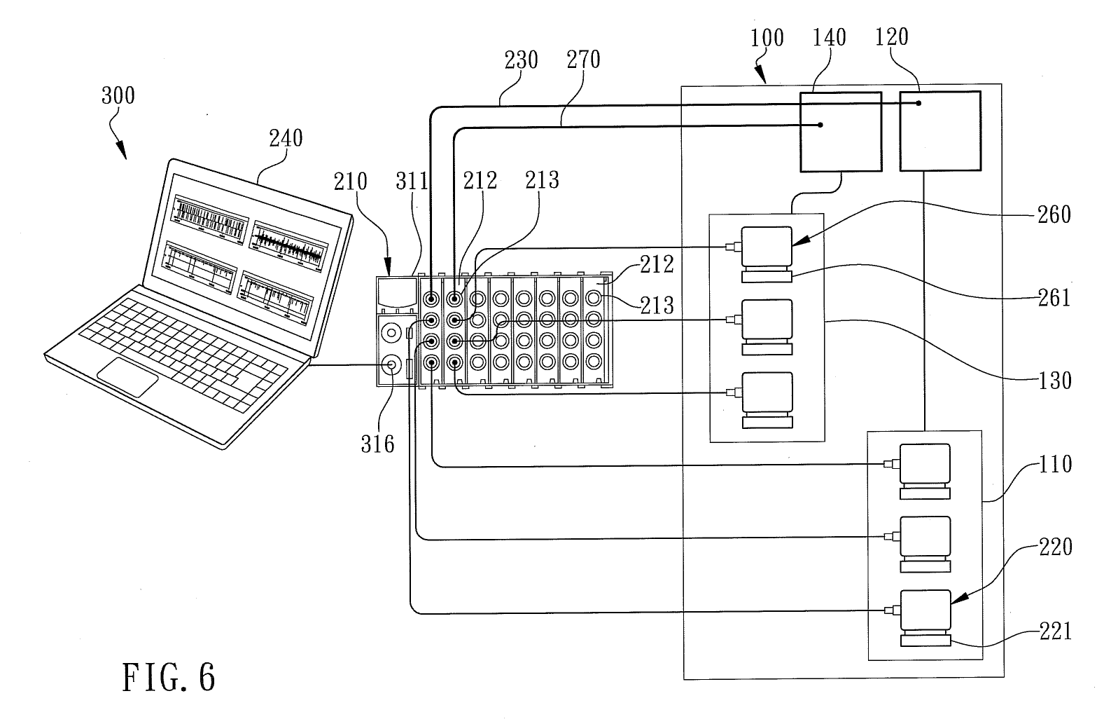

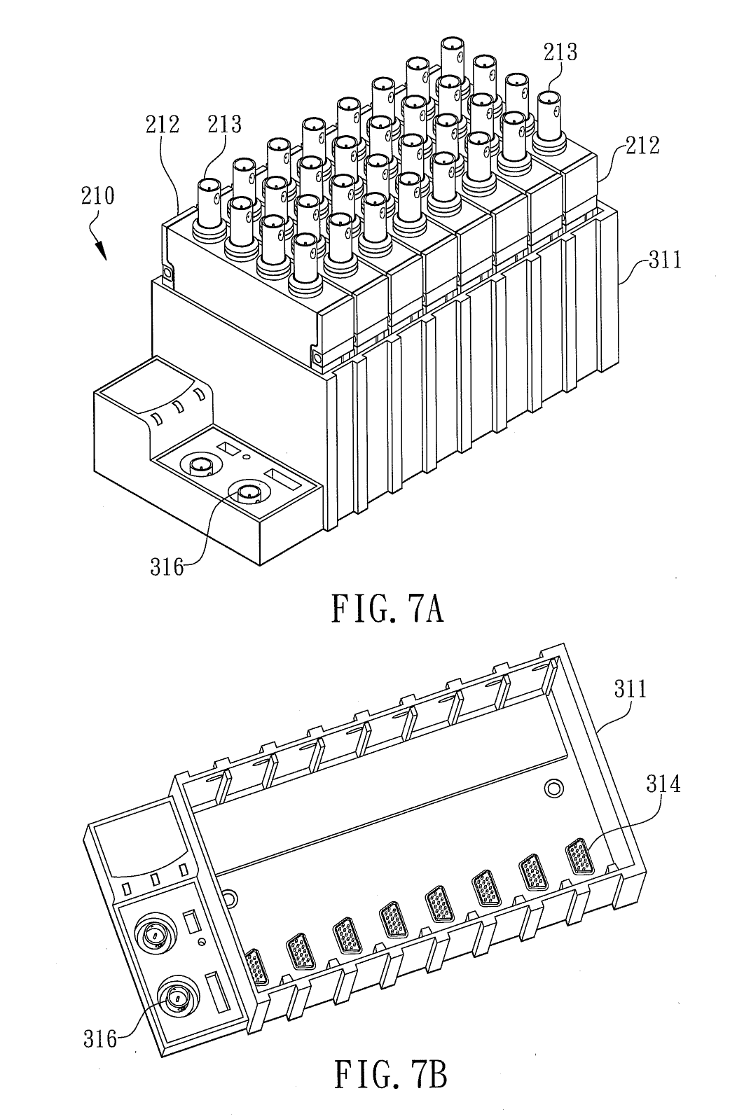

According to the second embodiment of the present invention, another controlling device 300 for abnormality prediction of semiconductor processing equipment 100 is illustrated in FIG. 6 for a major structural drawing. The semiconductor processing equipment 100 has a first variable-frequency rotating mechanism 110 and a first controller 120 to drive the first variable-frequency rotating mechanism 110. The controlling device 300 includes a multiplexer 210, a plurality of first vibration sensors 220, a first control signal wire 230, and a vibration spectrum analyzer 240 where the major components with the same functions as described in the first embodiment are described with the same numbers without any further description herein. In the present embodiment, the multiplexer 210 includes an adapter 311 which is a multi-cassette type adapter to modularly connect to a plurality of modularized multi-channel connecting assemblies 212. As shown in FIG. 7A, in the present embodiment, the adapter 311 can modularly connect eight modularized multi-channel connecting assemblies 212 in maximum where each modularized multi-channel connecting assembly 212 has four signal connecting terminals 213, therefore, the adapter 311 can modularly connect up to 32 signal connecting terminals 213 to give flexibility to increase or decrease the numbers of modularized multi-channel connecting assemblies 212 that are connected to acquire the vibration signals and the corresponding control signals from different vibration parts 111 of the semiconductor processing equipment 100, i.e., to acquire the vibration signals and the corresponding control signals from a plurality of variable-frequency rotating mechanisms 110 in the same semiconductor processing equipment 100 or to acquire the vibration signals and the corresponding control signals from a plurality of semiconductor processing equipment 100.

The cassette-type structure of the adapter 311 is illustrated in FIG. 7A and FIG. 7B where the adapter 311 has a plurality of connecting ports 314 and each connecting port 314 can connect to a modularized multi-channel connecting assembly 212. The adapter 311 further includes at least an output port 316 to connect to an external PC, an analyzer, an A/D converter, a display, or a recorder.

As shown in FIG. 6 again, the semiconductor processing equipment 100 further has a second variable-frequency rotating mechanism 130 and a second controller 140 to drive the second variable-frequency rotating mechanism 130 where the second variable-frequency rotating mechanism 130 is connected to the second controller 140 to operate and drive the second variable-frequency rotating mechanism 130.

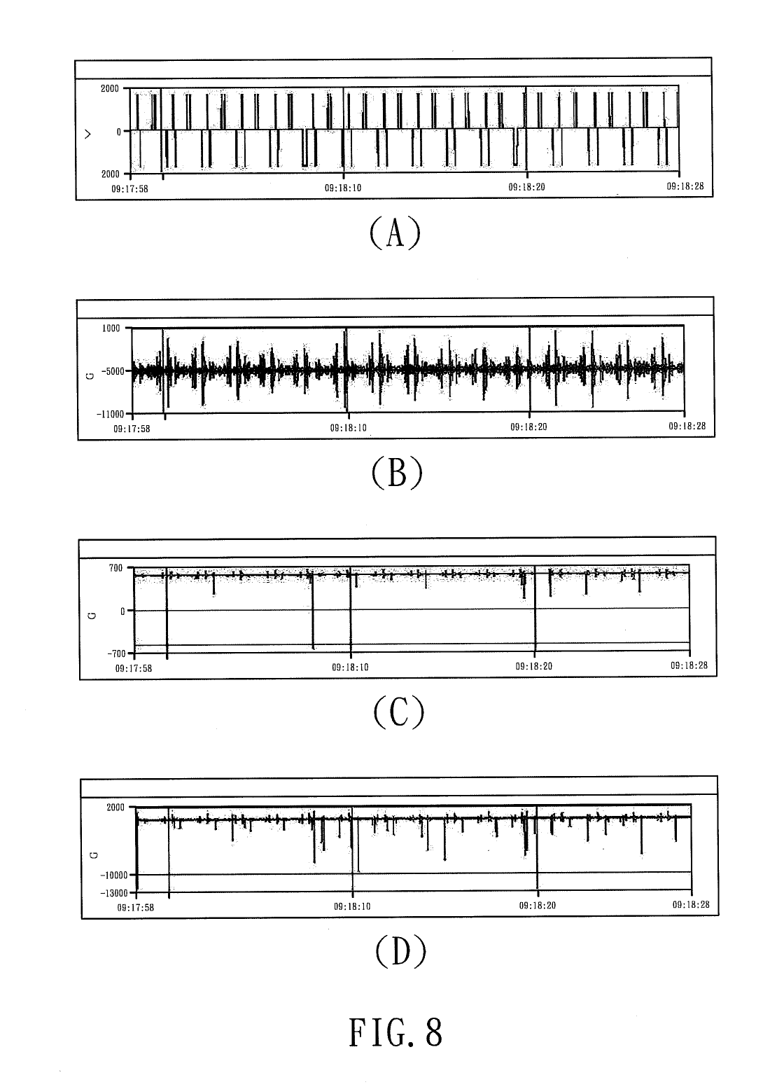

The controlling device 300 further includes a plurality of second vibration sensors 260 and a second control signal wire 270 where the second vibration sensors 260 are non-destructively installed on one or more vibration parts of the second variable-frequency rotating mechanism 130 and are connected to the signal connecting terminals 213. The total number of the connected first vibration sensors 220 and the second vibration sensors 260 are less than the total number of the signal connecting terminals 213 of the multiplexers 210 so that there are at least two unconnected signal connecting terminals 213 without connecting to the first vibration sensors 220 and the second vibration sensors 260 where one of the unconnected signal connecting terminals is connected to the first controller 120 by the first control signal wire 230, another one of the unconnected signal connecting terminals is connected to the second controller 140 by the second control signal wire 270. In this embodiment, each modularized multi-channel connecting assembly 212 has at least a signal connecting terminal 213 connected to a controller. The vibration signals and the corresponding control signals are collected and recorded through the connections of the signal connecting terminals 213 of the multiplexer 210 to the first vibration sensors 220, the first controller 120, the second vibration sensors 260 and the second controller 140 then finally to the vibration spectrum analyzer 240 through the output port 316 where the vibration signals and the corresponding control signals are transformed into time-domain waveforms through FFT as shown in FIG. 8. With further in-depth analysis, the possible abnormal equipment can be identified in time to remind equipment engineers to find the possible abnormal causes and make necessary actions before semiconductor processing equipment becomes abnormal.

In a various embodiment as shown in FIG. 8, the control signals of the first variable-frequency rotating mechanism 110 collected and recorded by the vibration spectrum analyzer 240 are transformed into control signal waveforms through FFT as shown in FIG. 8(A) and the vibration signals corresponding to the control signals are then transformed into vibration signal waveforms through FFT as shown from FIG. 8(B) to FIG. 8(D). Therefore, the vibration signal waveforms are acquired from different vibration parts of the first variable-frequency mechanism 110 having different vibration waveforms where the variation trend can be observed to set up prediction maintenance schedules of the semiconductor processing equipment 100.

A controlling method for abnormality prediction of semiconductor processing equipment 100 is also disclosed in the present invention to collect and record the control signals according to time sequence to calculate the vibration RMS of one or more vibration parts 111 of the first variable-frequency rotating mechanism 110 to set up SPC control limits. The definition of RMS is listed as follows,

$${x}_{rms} = \sqrt{\frac{{x}_{1}^{2} \vert {x}_{2}^{2} \vert … \vert {x}_{n}^{2}}{n}} .$$

where
Xrms is the Root Mean Square
X₁ to Xₙ are the vibration amplitudes corresponding to designated numbers of vibration sensors
N is the designated numbers of vibration sensors corresponding to the same control signal

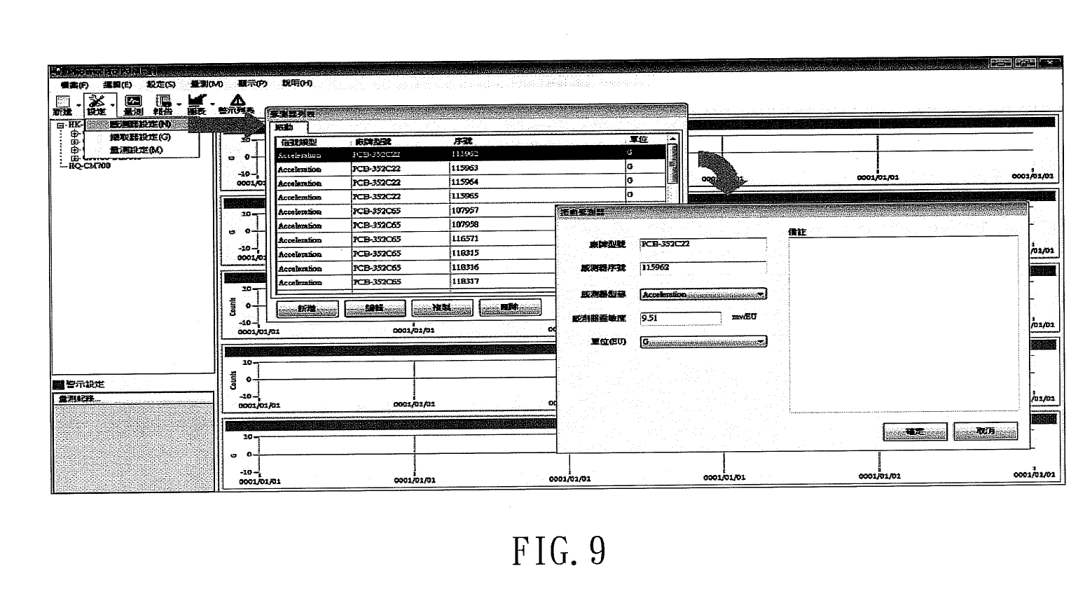

As shown from FIG. 9 to FIG. 21, the operation interfaces/windows of the vibration spectrum analyzer 240 are further illustrated to manifest the functions of the present invention.

As shown in FIG. 9, hardware setup for sensors is performed. Firstly, ICON of “Measurement Hardware Setup” is chosen, then “Sensor setup” is selected or “Sensor setup” can be pulled down from Tool bar where “Sensor setup table” is open and shown. Then, click the right mouse button to bring out “Sensor Menu” to provide at least three chosen items of “New Sensor”, “Edit Sensor”, and “Delete Sensor”. “New Sensor” is to bring out a setup window to set up a new sensor where signal types are provided by the system of the vibration spectrum analyzer 240 including Acc, Vel, Disp, Force or other sensors. Press “Confirm” when setup is done. The system automatically saves the new setup data where the pattern field and the unit field can be chosen which can be defined by referring to the block diagram of the controlling device 200. “Edit sensor” is to choose and edit an existing sensor from the existing sensor list where an edit window brings out to edit the chosen sensor. After editing some parameters of the chosen sensor, press “Confirm” to change and save the edited sensor or press “Save As” to save as a new sensor where sensor titles can not be the same which are automatically checked by the system. “Delete Sensor” is to delete an existing sensor from the existing sensor list. When a sensor is chosen to be deleted, the user is informed by a warning message showing “Confirm to Delete” sent by the system. Press “Yes” to delete the chosen sensor from the database. Before the system deleting the chosen sensor, the user is informed by another warning message showing “Reconfirm to Delete” sent by the system to reconfirm the deletion before deleting the chosen sensor.

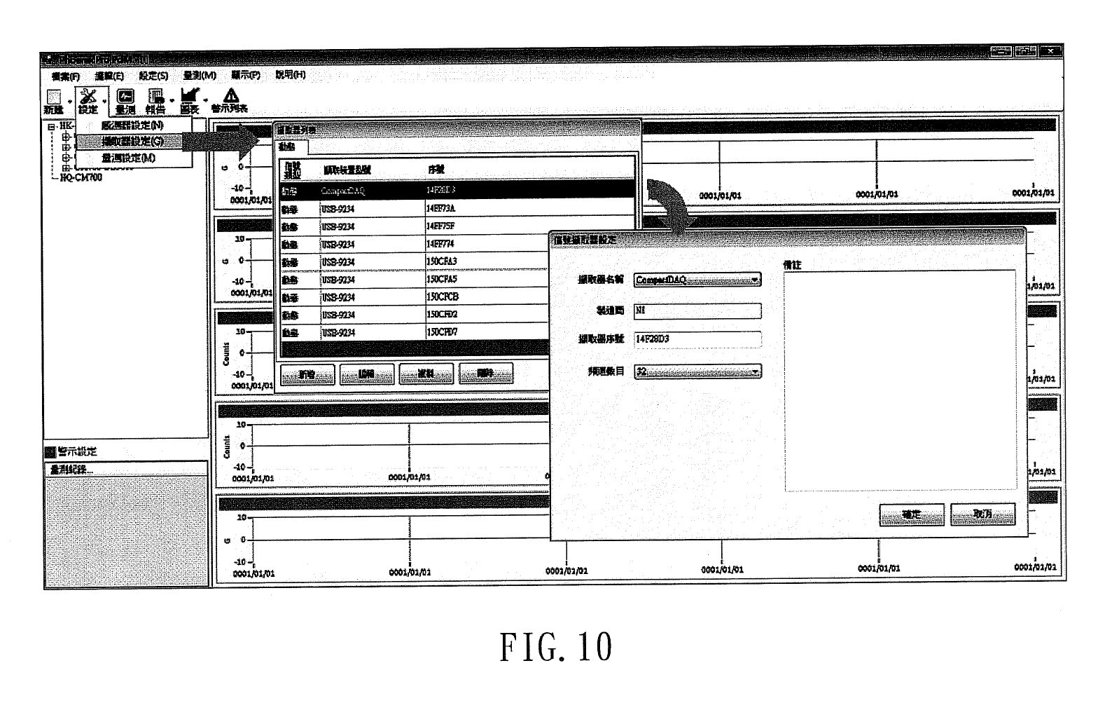

As shown in FIG. 10, hardware setup for DAQ is performed. ICON of “Measurement Hardware Setup” is chosen, then “DAQ setup” is chosen to bring out DAQ setup table where at least three chosen items are provided such as “New DAQ”, “Edit DAQ”, and “Delete DAQ” where DAQ stands for “Data Acquisition” and the corresponding hardware is the afore described multiplexers 210 and DAQ is the afore described multi-channel connecting assembly 212. The system provides different DAQ makers and models from different suppliers. After chosen the DAQ, a sub-table brings out to show the corresponding DAQ makers and models where detail specifications can be keyed in by the user. “New DAQ” is to bring up a DAQ setup table to set up a new DAQ. Press “Enter” when setup is done to complete the setup of a new DAQ where the maker field and the channel number field can be chosen which can be defined by referring to the block diagram of the controlling device 200. “Edit DAQ” is to choose and edit an existing DAQ from the existing DAQ list by doubt clicking the chosen DAQ then moving the cursor to the New/Edit table below to edit some parameters of the chosen DAQ. Then, press “Confirm” to change and save the edited DAQ or press “Save As” to save as a new DAQ where sensor titles can not be the same which are automatically checked by the system. “Delete DAQ” is to delete an existing DAQ from the existing DAQ list by double clicking at the chosen DAQ. When a DAQ is chosen to be deleted, the user is informed by a warning message showing “Confirm to Delete” sent by the system. Press “Yes” to delete the chosen DAQ from the database.

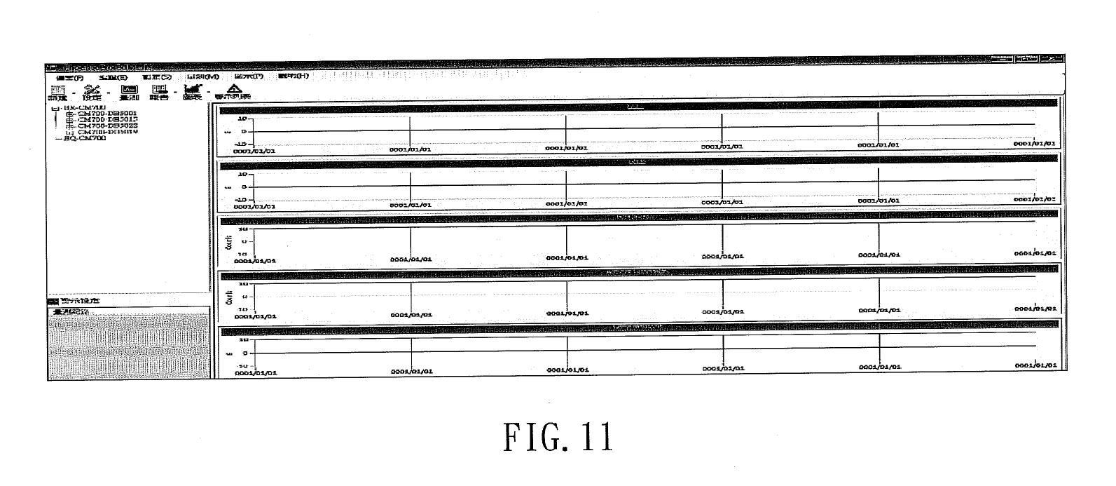

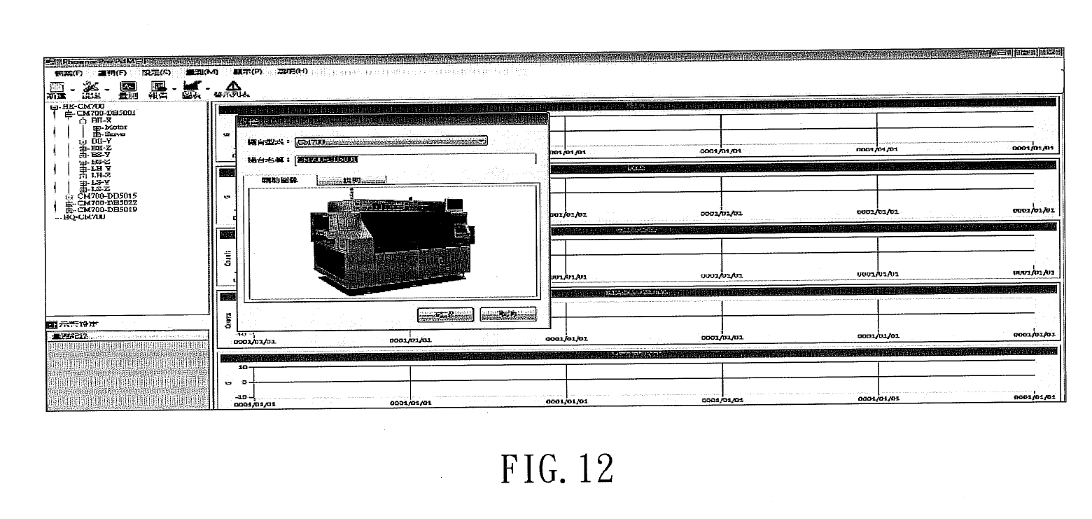

The management windows for managing semiconductor processing equipment 100 are shown in FIG. 11 and FIG. 12. Equipment management has four-level infrastructure including area/machine/equipment/parts where the monitoring signals include measurement points and treads such as RMS, Peak, Crest factor, Threshold peak no., Threshold Peak val. Each monitoring signal includes warning values and critical values where users can key in and save the related illustrating figures or text in image-assisted remark fields. Please pay special attention to the definition of equipment group including all the components of a driving motor to complete a work flow such as an equipment group including a server driving motor, ball bearing rod, working stage driven by a rod, or high-speed axis. Click the right mouse button at the dendritic structure to bring out operation windows where the operation includes four chosen items such as New/Copy/Paste/Delete. “New” is to create a blank field to key in new data. “Copy” is to copy data under the existing area/machine/equipment levels, not including measured data of the measurement points, to a temporary file, then paste the copied data to the dendritic structure to create a new area/machine/equipment. “Paste” is to paste the copied data with the highlighted title so that users can rename the title to be a new area/machine/equipment, however, “Paste” is only valid when pasting copied data within the same levels of database. Copied data from different levels can not be pasted. “Delete” is to delete the chosen area/machine/equipment from the existing list including measured data. When “Delete” commend is issued, the user is informed by a warning message showing “Confirm to Delete” sent by the system. Press “Yes” to delete the chosen item from the database.

Users can key in and save the related illustrating figures or text in image-assisted remark fields by clicking the left mouse button at the image-assisted windows where the system shows the figures or text in the image-assisted windows. The image-assisted windows can be enlarged or shrunk where the pre-set dimension is the original dimension of the image-assisted windows. Click at the right mouse button to bring out the operation windows of the image-assisted remark fields where the operation includes “New” and “Delete” where “New” is to create a data selection window to automatically search for figures and text. After confirmation, comments can be keyed into the remark fields for future reference.

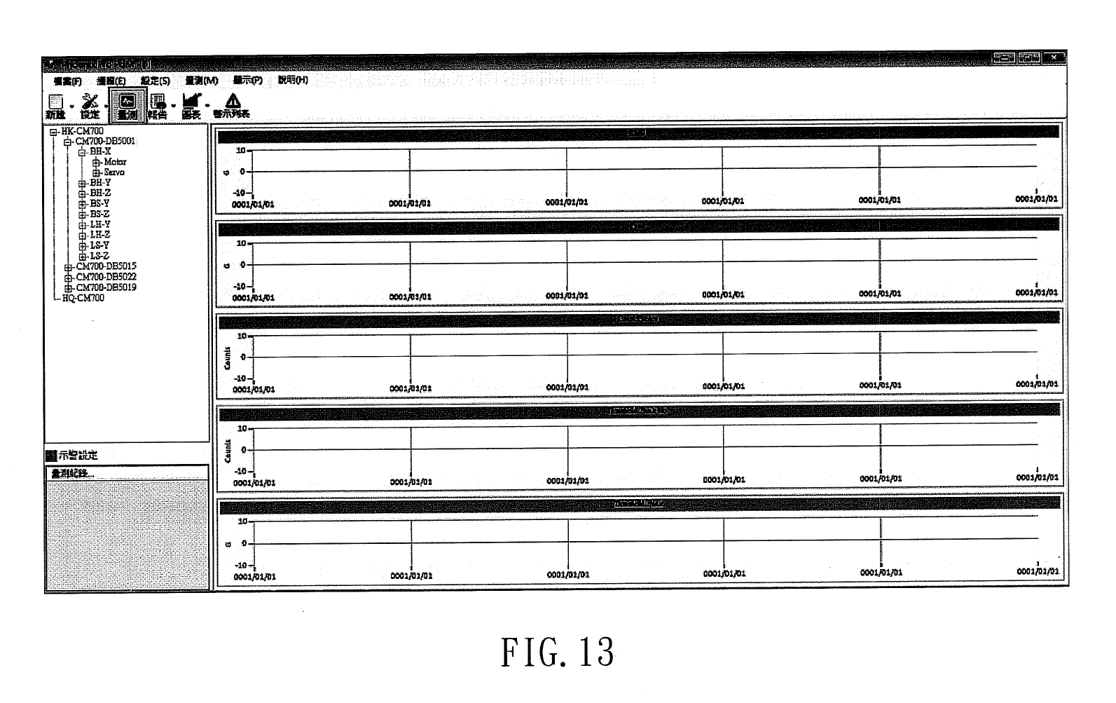

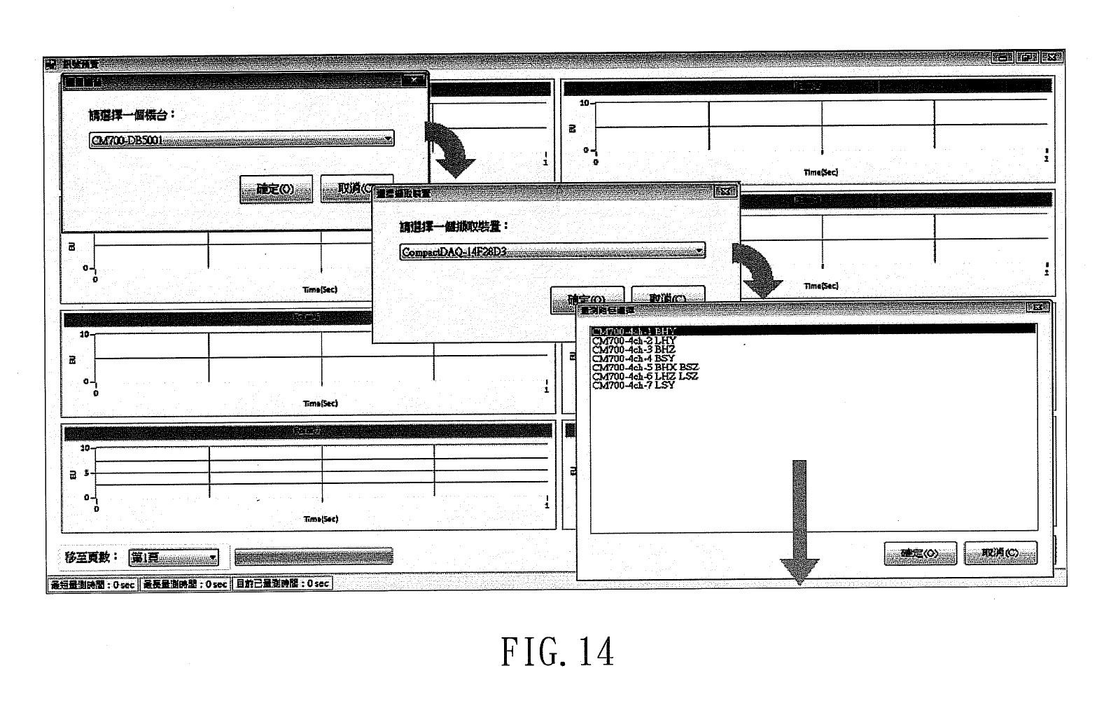

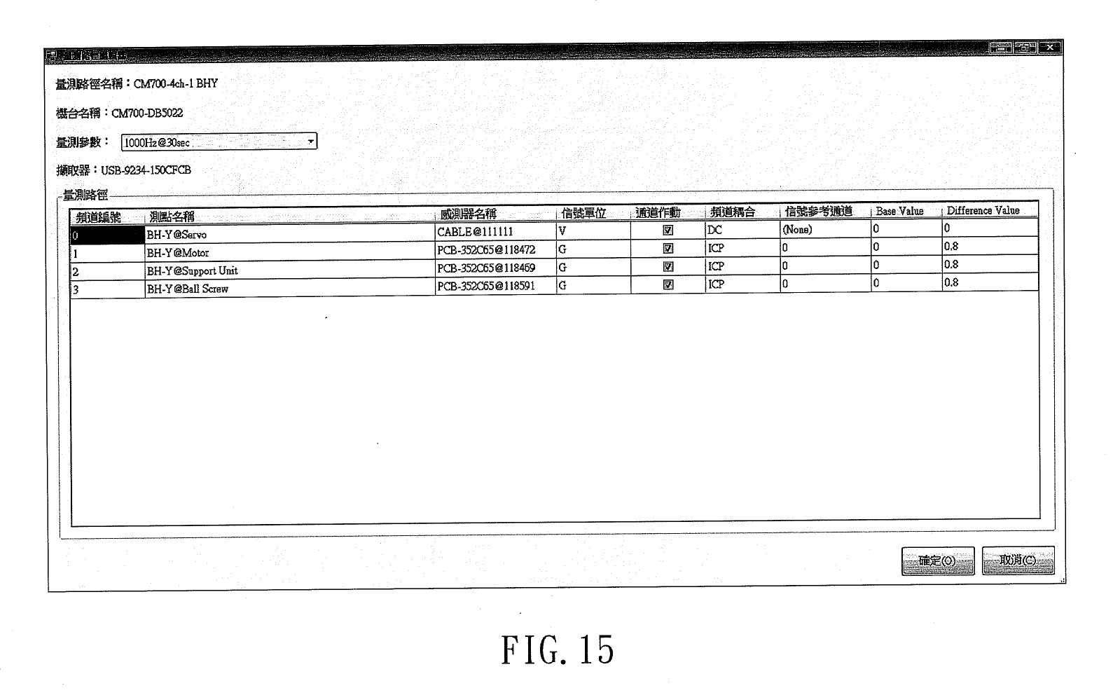

The operation to set up measurement and measurement paths is described as follows. Firstly, as shown in FIG. 13, select the ICON of “Measurement and Measurement Path Setup”. Then, press the right mouse button to bring out operation window as shown in FIG. 14 to provide “New Measurement Path”, “Copy Measurement Path”, “Paste Measurement Path”, “Select Measurement Path”, and “Delete Measurement Path”. “New Measurement Path” enables users to set up new measurement and the corresponding measurement path. The operation sequence is to set up DAQ in “DAQ Measurement Setup” window first. In the field of “Enter Setup Name”, select the existing DAQ (multi-cassette multiplexers) such as ASC-XXYYY machine with 32 channels. Then, the system provides a set of pre-set data including measurement bandwidth, measurement time, measurement mode, trigger channel, corresponding measureable channel numbers. When users press “Modify Measurement Setup” button, the field that can be modified is highlighted where users can modify the setup. The system automatically saves the modified DAQ setup after leaving the present setup. Then, select “Load Measurement Machine” in the function list by the mouse where users can set up the measurement path by clicking and dragging the selected machine into the corresponding table of measurement points in the selected area. Then, the system provides a measurement point for server control signals of a motor in addition to the numbers of the vibration measurement points of each set of equipment in the selected machine. The field of DAQ channel is to key in the numbers of the measurement points corresponding to DAQ signal channels where the channel upper limit is the maximum channel number provided by the system. After completing the setup, press “Save Measurement Path” and key in the name of the measurement path such as Machine #2 NIComp-32 2 kHz which represents that the present measurement path has selected NI Compdeck 32 channel DAQ with the sampling rate of 2 kHz. Users can select “Select Measurement Path” to download the files from the existing measurement path by clicking the right mouse button where the system shows all names of the existing measurement paths in the selected area. Then, press “Yes” where users is able to directly perform data measurement or modify the content of measurement paths, then save as a new measurement path and perform data measurement, as shown in FIG. 15. Furthermore, “Select Measurement Path” only can modify the content of the corresponding measurement points but not the measurement setup content of DAQ.

When measuring data, firstly, the sensor corresponding to the selected DAQ channel is set up where the existing vibration sensors can be listed from the system through the corresponding sensor window of the selected DAQ for users to choose. Furthermore, when signals are server control signals, then sensors can not be selected and the series number field shows “None”.

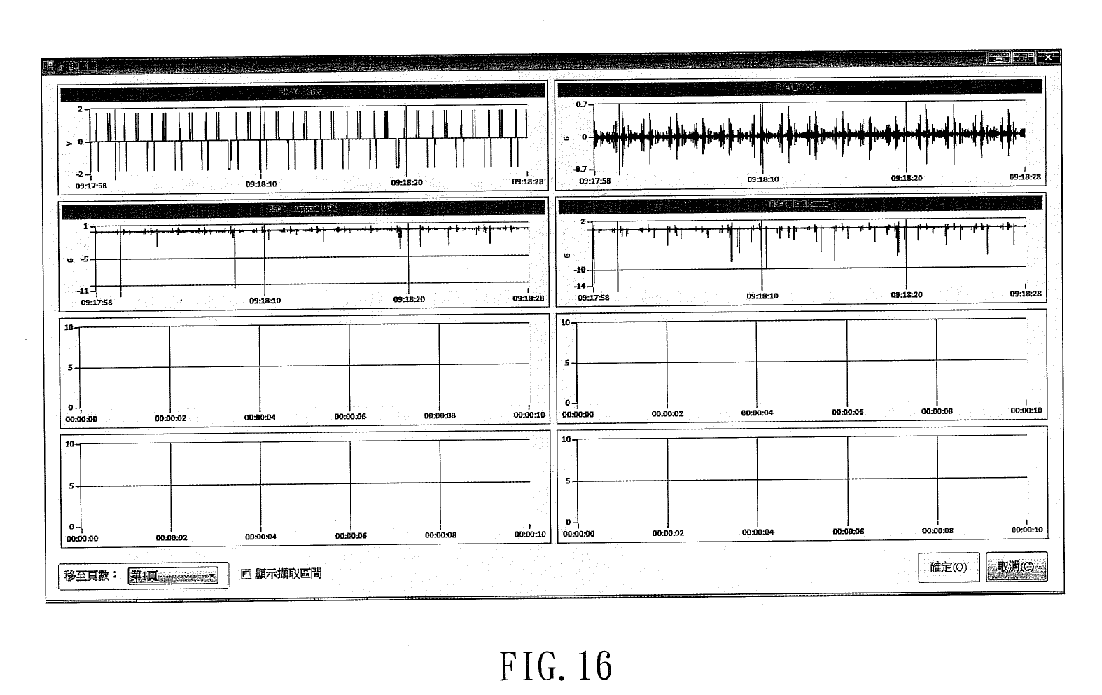

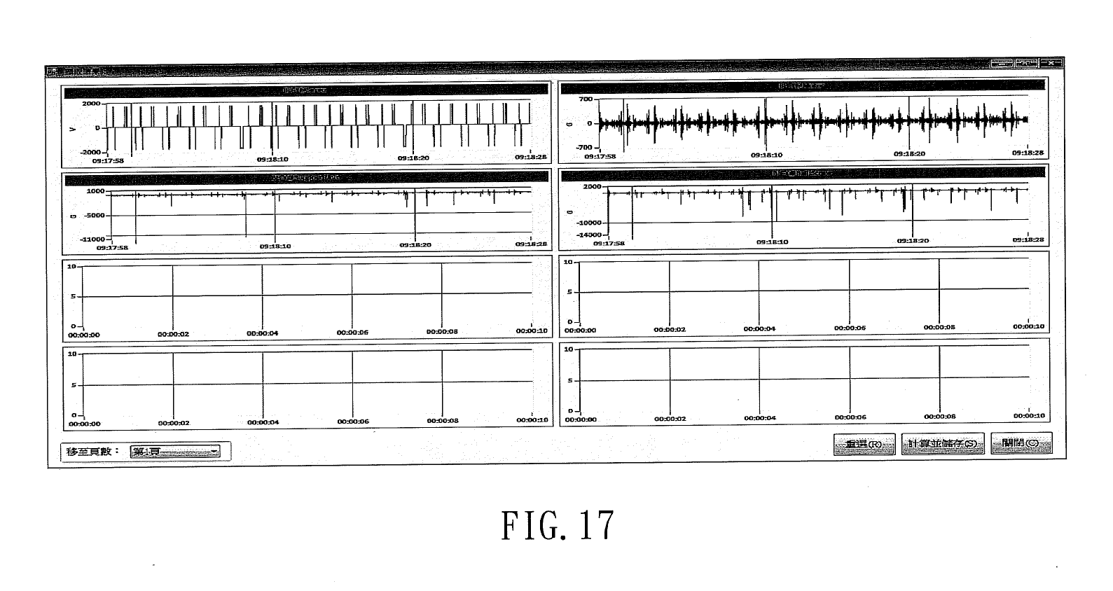

Before pressing the button of measurement confirmation in the signal measurement window as shown in FIG. 15, users have to select which measurement path is executed first. Path 1, for example, is selected where the measurement path of the corresponding window of the measurement point table is highlighted. Then, press “Start” to begin measurement where the system proceeds data measurement and analysis according to the measurement setup and the corresponding measurement path in the corresponding window of the measurement point table in DAQ measurement setup. During data measurement, the progress of the measurement is shown by bar charts to indicate measurement status. The measured control signals and the corresponding vibration signals are transformed into time-domain waveforms through FFT as shown in FIG. 16. After data measurement is complete and before users save the measured data, press “Inspect Original Signals” to review all the measured original signal waveforms from all the channels to see if the measured signals are correct or not. Then, users can press the right button or the left button at the bottom of “Inspect Original Signals” window and after confirmation of the acquired waveforms from all channels is correct, user can press “Calculate and Save” button at the bottom right corner as shown in FIG. 17. Then, the system saves all the measured data into the corresponding database for further trend analysis in the future.

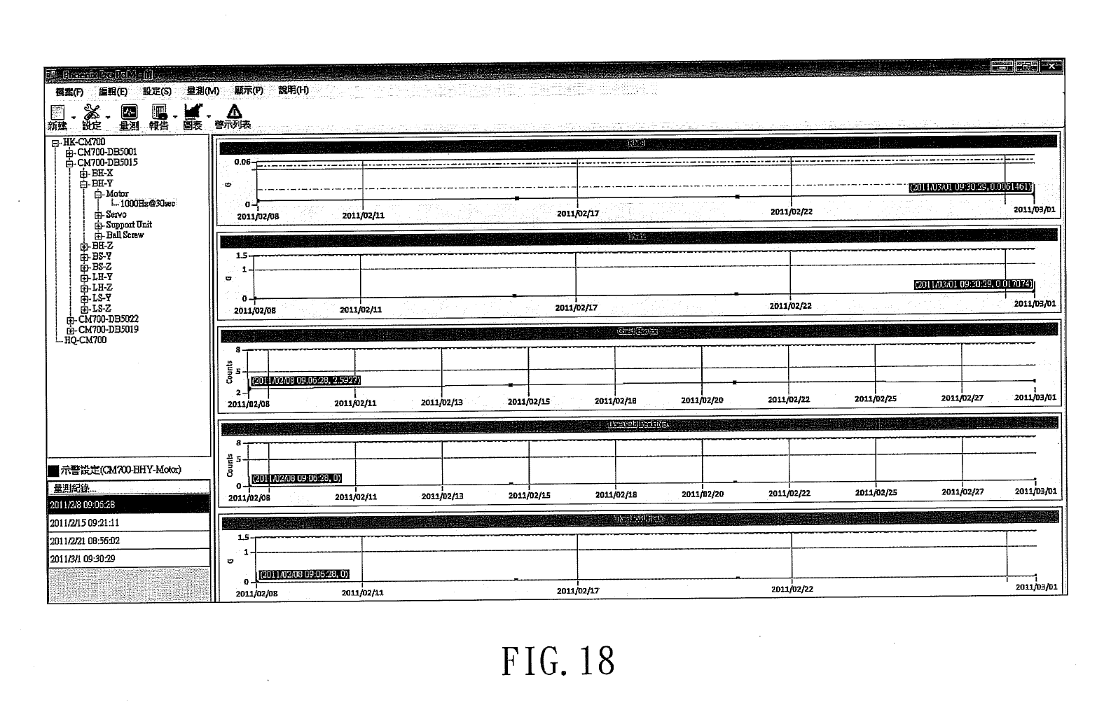

FIG. 18 is the operation window for trend analysis of measurement points. Select the ICON of “Graph” and press “Trend Analysis” button in the function field of the window where users are able to choose the equipment to be analyzed in the dendrite structure window in the left. The analysis area at the right shows the corresponding measurement points of the selected equipment, corresponding signals at the measurement points, warning limits, and critical limits. At the same time, the trend window shows the latest trend chart of the measured data where the preset number of data is 12. Data tables are shown at the bottom of the trend chart including measured time, data, and the status of the equipment of the measured data. Trend chart also provides cursor functions where the data in the data table are highlighted at the location of the cursor.

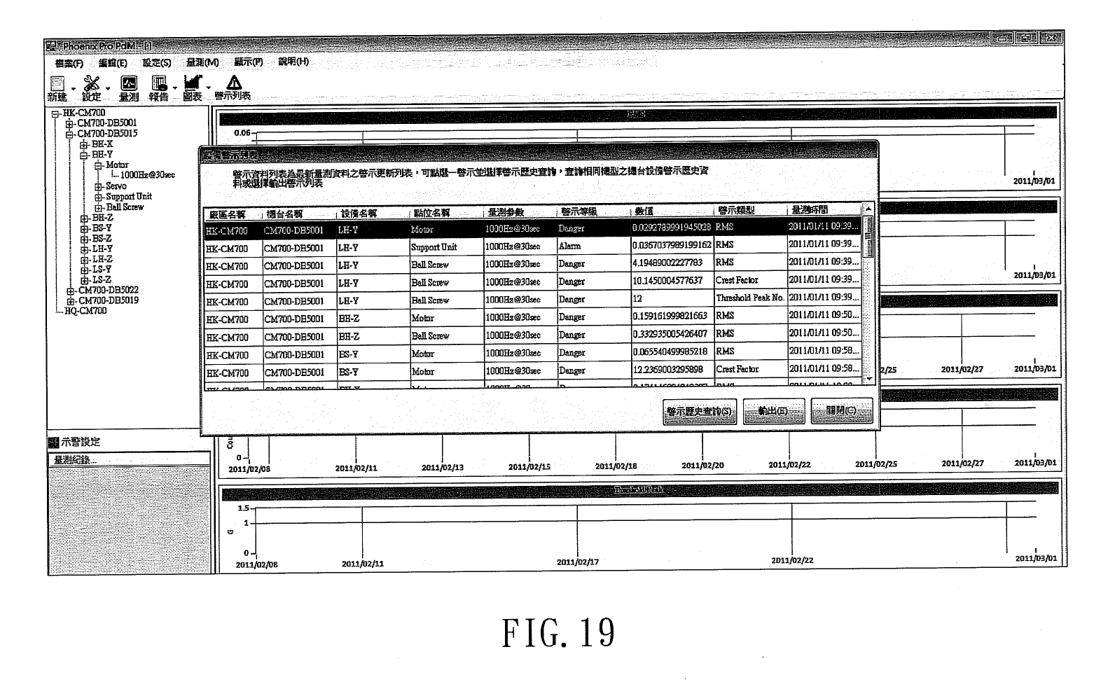

FIG. 19 is the operation window of the recent abnormal equipment list. Select the ICON of “Select Trend” and then press “Latest Abnormal Equipment” button in the function field of the window where the system searches all the equipment having the latest measured data close to warning limits or critical limits in the selected area and then list out all the detail information in the table. Users are able to view all the abnormal equipment in the selected area through the table of the latest abnormal equipment list.

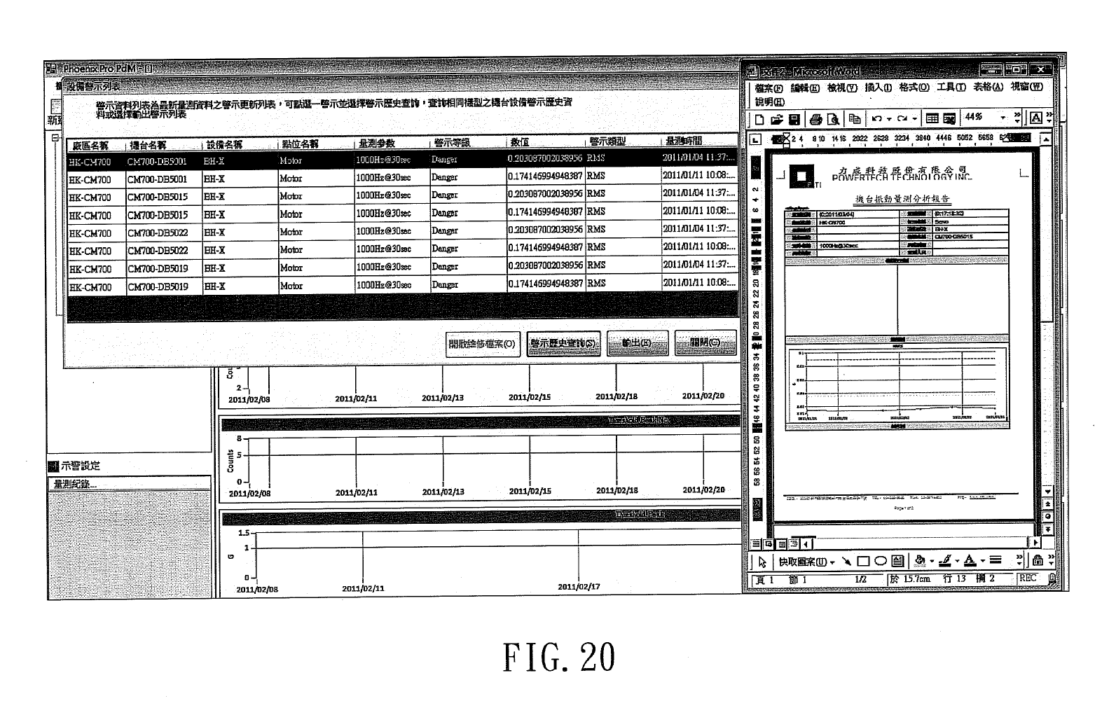

The records of diagnosis and maintenance/repair are described as follows. As shown in FIG. 20, vibration spectrum analyzer provides two different problem recording formats. One is problem diagnosis record. Problems diagnosis and improvement suggestions proposed through trend analysis and waveform spectrum signal analysis is keyed in and saved by the system for extreme critical equipment. Users can use the functions such as time sequence or machine sequence to quickly search for the diagnosis history and the corresponding improvement suggestions as references to diagnosis the present problems. The other is equipment maintenance/repair record where equipment engineers can refer to the problem diagnosis record to take improvement actions and the results are recorded in equipment maintenance record as maintenance/repair history for future reference.

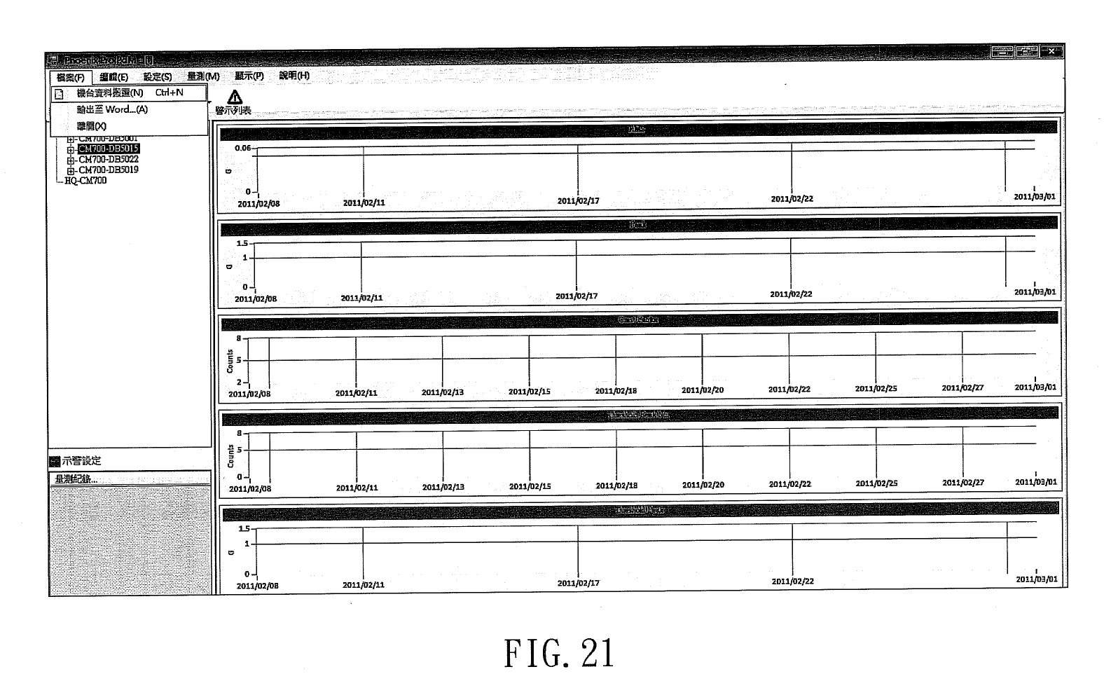

The operation window of database export/import is shown in FIG. 21. All the measured data in the selected area are saved to the designated location through export function. Select ICON of “Data Export/Import” and wait until the window of “Project Setup” brings out where users can select the store location the measured data from the dendritic window, i.e., move the cursor to the selected location and press the left mouse button to highlight the selected location then press the right mouse button to bring out “Data Export/Import” window. After selecting “Data Export”, the system brings out a window to select the store location. After selecting the store location, measured data are exported where the system exports the measured data by the name according to the selected area, date, and time. When select “Data Import”, the system imports the selected data including the area data into database and show in the dendritic window. If the same names are encountered, system would give warning before replacing the data.

The above description of embodiments of this invention is intended to be illustrative but not limited. Other embodiments of this invention will be obvious to those skilled in the art in view of the above disclosure which still will be covered by and within the scope of the present invention even with any modifications, equivalent variations, and adaptations.

What is claimed is:

1. A controlling device for abnormality prediction of semiconductor processing equipment, the semiconductor processing equipment including a first variable-frequency rotating mechanism and a first controller to drive the first variable-frequency rotating mechanism, the controlling device comprising:
a multiplexer including an adapter and at least a modularized multi-channel connecting assembly plugged into the adapter, wherein the modularized multi-channel connecting assembly has a plurality of signal connecting terminals;
a plurality of first vibration sensors being non-destructively installed on one or more vibration parts of the first variable-frequency rotating mechanism and connected to the signal connecting terminals, wherein the number of the connected first vibration sensors is less than the number of the signal connecting terminals of the multiplexer so that at least one of the signal connecting terminals is unconnected with the first vibration sensors;
a first control signal wire connecting the first controller to the unconnected signal connecting terminal; and
a vibration spectrum analyzer connected to the adapter to collect and record the vibration signals and the corresponding control signal and transform into time-domain waveforms through FFT.

2. The controlling device as claimed in claim 1, wherein the vibration parts attached by the first sensors include a vibration source, a vibration source fixing element, and a vibration transmission element.

3. The controlling device as claimed in claim 1, wherein each first vibration sensor has a magnetic sensing head and a body, and the controlling device further comprises a plurality of magnetic attachments pre-attached to the vibration parts of the first variable-frequency rotating mechanism for the magnetic connection of the magnetic sensing heads.

4. The controlling device as claimed in claim 3, wherein the body of each of the first vibration sensors has a screw rod modularly jointed with the magnetic sensing head.

5. The controlling device as claimed in claim 3, wherein the dimension of the magnetic attachments is the same as or slightly larger than the dimension of the magnetic sensing heads.

6. The controlling device as claimed in claim 1, wherein the adapter is a high-speed USB carrier.

7. The controlling device as claimed in claim 1, wherein the first control signal wire has a tolerance voltage ranged within ±5 volts between the first controller and the corresponding signal connecting terminal.

8. The controlling device as claimed in claim 1, wherein the adapter is single-cassette type adapter to modularly joint to one single multi-channel connecting assembly.

9. The controlling device as claimed in claim 1, wherein the adapter is multi-cassette type adapter to modularly joint to a plurality of multi-channel connecting assemblies.

10. The controlling device as claimed in claim 9, wherein the semiconductor processing equipment further includes a second variable-frequency rotating mechanism and a second controller to drive the second variable-frequency rotating mechanism, and the controlling device further comprises a plurality of second vibration sensors and a second control signal wire, wherein the second vibration sensors are non-destructively installed on one or more vibration parts of the second variable-frequency rotating mechanism and connected to the signal connecting terminals, wherein the number of the connected first and second vibration sensors is less than the number of the signal connecting terminals of the multiplexer so that at least another one of the signal connecting terminals is unconnected with the first and second vibration sensors, and the second control signal wire connects the second controller to the another unconnected signal connecting terminal.

11. A method for abnormality prediction of semiconductor processing equipment where the semiconductor has a first variable-frequency rotating mechanism and a first controller to drive the first variable-frequency rotating mechanism, the method primarily comprising:
setting up a controlling device for abnormality prediction of semiconductor processing equipment as claimed in claim 1;
using a collected control signal from the first control signal wire as time base; and
calculating the root mean square of the vibration parts when activation of the first variable-frequency rotating mechanism to set up a plurality of statistic process control limits for abnormality.

12. The method as claimed in claim 11, wherein the adapter is multi-cassette type adapter to modularly joint to a plurality of multi-channel connecting assemblies.

13. The method as claimed in claim 12, wherein the semiconductor processing equipment further includes a second variable-frequency rotating mechanism and a second controller to drive the second variable-frequency rotating mechanism, and the controlling device further comprises a plurality of second vibration sensors and a second control signal wire, wherein the second vibration sensors are non-destructively installed on one or more vibration parts of the second variable-frequency rotating mechanism and connected to the signal connecting terminals, wherein the number of the connected first and second vibration sensors is less than the number of the signal connecting terminals of the multiplexer so that at least another one of the signal connecting terminals is unconnected with the first and second vibration sensors, and the second control signal wire connects the second controller to the another unconnected signal connecting terminal.
